(19) United States
(12) Patent Application Publication
(10) Pub. No.: US 2003/0121201 A1
(43) Pub. Date: Jul. 3, 2003

(54) Polysaccharide mushroom compost supplements

(76) Inventors: Kurt R. Dahlberg, Malinta, OH (US); Dena L. LaPolt, Bowling Green, OH (US)

Correspondence Address: MORGAN LEWIS & BOCKIUS LLP, 1111 PENNSYLVANIA AVENUE NW, WASHINGTON, DC, 20004, US

(21) Appl. No.: 10/000,094

(22) Filed: Dec. 4, 2001

(51) Int. Cl. A01G 1/04

(52) U.S. Cl. 47/1.1

(57) ABSTRACT

The present invention provides an improved nutrient supplement that increases the yield of mushrooms, especially Agaricus bisporus. The nutrient supplement consists of polysaccharides (especially cellulose) or polysaccharide-containing materials. The polysaccharides or polysaccharide-containing materials may be mixed with protein-containing and/or vegetable oil-containing materials and/or may be treated to increase the availability of the carbohydrate to the mushroom fungus.

### FIELD OF THE INVENTION

The present invention relates to the art of mushroom cultivation and specifically pertains to an improved mushroom supplement that increases mushroom yield while avoiding deleterious temperature surges and the growth of foreign microorganisms. The supplement eliminates or minimizes the use of physical or chemical treatments.

### BACKGROUND OF THE INVENTION

All references and patents cited herein are hereby incorporated by reference in their entireties. It must be noted that as used in this specification and the appended claims, the singular forms “a”, “an” and “the” include plural referents unless the context clearly dictates otherwise. Thus, for example, reference to “a polysaccharide” includes mixtures and large numbers of such polysaccharides, reference to “an enriched mushroom compost supplement” includes large numbers of enriched mushroom compost supplements, reference to “a method of increasing mushroom yield” includes one or more methods or steps of the type described herein.

Mushroom Compost

The commercial production of mushrooms such as Agaricus bisporus involves a series of steps, including compost preparation, compost pasteurization, inoculating the compost with the mushroom fungus (spawning), incubation to allow thorough colonization of the compost with mushroom mycelia (spawn run), top dressing the compost with moistened peat moss (casing), and controlling the environment to promote the development of mature mushrooms. The mushroom growing process is described in detail in several publications (for example, Chang & Hayes, 1978; Flegg, et al., 1985; Chang & Miles, 1989; Van Griensven, 1988).

Typical compost formulas use wheat straw, horse stable bedding (mostly straw, and also referred to as horse manure), grass hay, or other lignocellulosic materials. Other lignocellulosic materials may be used provided that they are inexpensive and readily available sources of carbon. Poultry litter, vegetable meals (cottonseed meal, soybean meal, etc.) or other inexpensive ingredients are added to provide nitrogen. Mushroom composts also are typically amended with gypsum to reduce greasiness and balance pH.

The initial stages of composting (referred to as pre-wet and Phase I) may occur outdoors, under roofs, or in composting bunkers. Ingredients are thoroughly mixed and moistened. The composting process causes temperatures to increase to 70° to 80° +C. (ca. 155° to 175° +F.). Deamination of protein sources results in the release of ammonia into the mixtures, and compost pH values become alkaline (pH 8.3 to 8.6+). Compost piles are turned at specific intervals throughout the process. At the completion of a pre-wet/Phase I process, the straw is physically broken into smaller fragments, straw is abraded to allow the entry of moisture and microorganisms into the fibers, the waxy straw coating is removed, and the substrate is softened. The compost is moistened to ca. 68 to 72% moisture. The Phase I compost is then filled into trays, fixed beds or shelves, or bulk tunnels for further processing. The physical changes in the substrate allow large amounts of the substrate to be filled into the containers.

Phase II of the composting process involves allowing temperatures to equilibrate followed by pasteurization to remove pests and pathogens. The compost is allowed to “condition” for about 5 to 9 days. During this period, a population of thermophilic microorganisms replaces the mixture of mesophilic and thermotolerant microorganisms. The straw is further softened and degraded by the microbial populations. Free ammonia is either released to the air or fixed by the microbial populations. The pH is reduced to near neutrality. The compost develops a “selectivity” in which microbial pests and pathogens are unable to grow. It is believed that the readily available nutrients present in the starting materials are either metabolized or ingested by the microbial population, rendering them unavailable to pests and pathogens. The mushroom fungus, Agaricus bisporus, is capable of ingesting the microbial population for its nutritional needs.

Once the Phase II process is complete, the compost is cooled to less than about 78° F. and inoculated with mushroom spawn. The mushroom fungus Agaricus bisporus colonizes the compost over a period of about 7 to 16 days. The compost is then top-dressed with a “casing layer.” The casing layer frequently consists of peat moss that is moistened and amended with ground limestone, hydrated lime, spent lime, or other material to neutralize the pH. The casing layer also may be amended with “casing spawn” (e.g., U.S. Pat. Nos. 5,503,647 and 6,073,388; each of which is hereby incorporated by reference in its entirety) to speed its colonization with the mushroom fungus. After the fungal mycelium grows throughout the casing layer (ca. 4 to 10 days), environmental conditions are changed to induce mushroom fruiting. Mature mushrooms are typically harvested within 14 to 20 days after casing. Mushrooms are then produced in a series of approximately weekly “breaks” or “flushes” over a period of several weeks.

The current methods used for the preparation of mushroom compost are the only economically practical way of producing a mushroom substrate. The advantages of the composting process are that the substrate is relatively inexpensive, and that the substrate supports the growth of the mushroom fungus but generally excludes the growth of pests, pathogens, and competing microorganisms. One disadvantage of the mushroom composting process is that it is variable, depending on ingredient quality and availability, weather conditions (for outside composting operations), and the judgements of the composting operators. For example, minor changes in compost moisture content can have profound effects on the ultimate yield of mushrooms grown on the substrate. Brief periods of anaerobiosis in compost piles during Phase I can adversely affect mushroom production.

One major issue with successful mushroom compost preparation is the definition of the completion of the process. Mushroom compost typically loses around 50% of its dry weight during the Phase I and Phase II processes. “Green” compost that has not lost the necessary dry weight may contain readily available carbon sources. These carbon sources may provide nutrients to competing microorganisms during spawn run and result in high substrate temperatures that are detrimental to the mushroom fungus. Green compost may also support the growth of specific pathogens, such as the “green mold” Trichoderma harzianum. This disease has caused devastating losses to mushroom production in many locations. Green compost also has a low density. It is difficult to fill economically useful amounts of green compost into trays or beds.

A mushroom substrate that has been composted too long loses a significant portion of its dry weight, especially polysaccharides. Nutrients that are important to the mushroom fungus are lost to the atmosphere and the microbial population. Excessively “dark” compost has a reduced mushroom yield potential. In addition, dark compost often has low metabolic activity, and the moderate temperature increases that are useful to the mushroom growing process are absent.

Mushroom Supplements

Many mushroom growers add nutrient supplements to the mushroom compost at the time of spawning or casing. Because of the danger of spreading diseases, especially at tray-type mushroom farms, most mushroom growers add supplements at spawning. Addition of such supplements usually results in an increase in mushroom yield. Nutrient supplements generally consist of proteinaceous materials such as cracked soybean particles, soybean meal, corn gluten meal, feather meal, and similar materials. For example, in Hughes et al. (U.S. Pat. No. 3,560,190; which is hereby incorporated by reference in its entirety), a dry formulation based on a combination of cottonseed meal and cottonseed oil is disclosed as a suitable supplement.

Nutrient supplementation, however, is susceptible to some undesirable effects. One problem that has been encountered is excessive bed heating, apparently caused by the ready availability of the nutrient source to the highly active microbial population in the compost. Temperature excursions above 35° C. (95° F.), sufficient to significantly deplete, if not completely destroy the mushroom mycelia have been observed. Another problem is encountered when adding the supplement to the compost at the time of spawning. In many cases, other microorganisms, (primarily molds, preexisting in the compost, introduced with the supplement, or introduced via airborne contamination) compete with the mushroom mycelium for the added nutrients. This reduces the availability of the supplement for its intended purpose, and often hinders the development of the mushroom mycelium.

Recognizing these problems, Carroll et al. (U.S. Pat. No. 3,942,969; which is hereby incorporated by reference in its entirety) provides a supplement suitable for addition to the compost at the time of spawning, in which the release of the nutrient is delayed. The supplement comprises a denatured protein source, including protein derived from cottonseed, soybean, and peanuts. As disclosed, the denaturing can be accomplished by heat treating or by treatment with alkalies, acids, or formaldehyde. Unfortunately, the potential gains in mushroom yields are disadvantageously offset by the economic penalty associated with the denaturation treatment. The potential health and environmental hazards of denaturing treatments such as formaldehyde are also a disadvantage.

Wu (U.S. Pat. No. 4,534,781; which is hereby incorporated by reference in its entirety) teaches an improved nutrient supplement comprising a particulate nutrient, such as a cracked soybean particle, coated with a hydrophobic material that is not readily assimilable by competing microorganisms in the compost. A further improvement in this technology was taught by Wu & Bretzloff (U.S. Pat. No. 4,617,047; which is hereby incorporated by reference in its entirety) in which the protein containing nutrient is coated with a hydrophobic material and a mold inhibitory composition. Again, the potential gains in mushroom yield are disadvantageously offset by the cost associated with the antimicrobial treatments. The cost and potential health and environmental hazards of the mold inhibitory treatments are also a disadvantage.

Katz et al. (Eur. Pat. Publ. 0 0290 236; which is hereby incorporated by reference in its entirety) teach another nutrient supplement for mushroom cultivation, prepared by coating protein rich particles with a hydrophilic carbohydrate. This coating also retards the release of nitrogen into the medium. Pratt et al. (U.S. Pat. No. 4,764,199; which is hereby incorporated by reference in its entirety) teach a mushroom growing supplement prepared from acidic corn gluten meal treated with aqueous formaldehyde while maintaining the meal in a free flowing condition.

Romaine & Marlowe (U.S. Pat. Nos. 5,291,685 and 5,427,592; each of which is hereby incorporated by reference in its entirety) teach another nutrient supplement for mushroom cultivation in which intact seeds, such a rapeseed, or other small oilseed are heat treated, such as at 195° F. for 24 hours. The heat treatment prevents sprouting and provides a delayed release mechanism for seed nutrients. The Romaine & Marlowe supplement is used at fairly high rates of between 7 and 14% of the dry weight of the compost.

Currently used mushroom supplements involve treating nutrients with heat or chemicals to reduce the availability of the nutrients to competing microorganisms in the compost. In all cases, treatments represent a significant portion of the cost of the supplement. In the case of chemical treatments of the supplements, ingredients such as formaldehyde and various pesticides represent potential health and environmental hazards, and the practicality of using such agents may be reduced due to regulatory issues. The development of mushroom supplements without using such chemicals is highly desirable.

Sartor & Brini (European Patent Application EP 0 700 884 A1; which is hereby incorporated by reference in its entirety) and Sartor et al. (U.S. Pat. No. 5,979,109; which is herein incorporated by reference in its entirety) teach a mixture of a water retaining-dispersing agent (e.g., peat), a buffer, a protein containing component (e.g. soybean meal), a growth promoting component (e.g. corn gluten and/or corn starch), and water. The mixture is sterilized, colonized with the mushroom fungus, and used to spawn mushroom compost. The formulation inoculates the mushroom beds and adds protein, while eliminating residual antimicrobial substances and suppressing the growth of antagonistic molds.

Kananen et al. (U.S. Pat. Nos. 6,029,394 and 6,041,544; each of which is hereby incorporated by reference in its entirety) teach a “spawn-supplement” in which a nutritive substrate is colonized with the mushroom fungus and functions as both mushroom spawn and supplement. The mushroom mycelium exerts a protective effect on the nutrients and prevents the growth of competitor microorganisms. The substrates typically contain a proteinaceous ingredient in an amount to provide at least 1.0% nitrogen (about 6.5% protein) on a dry weight basis and at least 25,000 particles per 100 g of finished product. Kananen et al. Claim the addition of 2 to 30% “paper pellets” in the spawn-supplement formulas. Given that the paper pellets contain 53% paper and the spawn supplement formulas contain 40 to 54% moisture, the spawn-supplement contains 0.46 to 9.5% paper in the finished product. Kananen et al. note that the paper serves to provide multiple points of inoculum and water holding capacity.

All previous technologies related to mushroom supplements are based on the addition of protein to the compost. Variations in the products that are commercially available include the source and amount of the protein (e.g., soybean meal, cracked soybeans, ground soybeans, corn gluten meal, feather meal, whole canola seeds, etc.). These ingredients typically contain low levels of polysaccharides and/or cellulose. For example, The National Academy of Sciences (1971) shows the crude fiber content of corn gluten of 5.1%. Soybean meal contains 7.1% crude fiber. Rape seeds (canola) contain 7.3% crude fiber. Given that crude fiber content approximates the content of polysaccharides and cellulose, these proteinaceous ingredients contain little polysaccharide and cellulose. Product variations also include the method of preventing microbial attack and compost temperature surges (e.g., formaldehyde treatment, fungicides, heat treatment, and the biological effect of colonization with the mushroom fungus). Some supplement formulations also contain vegetable oils derived from soybeans, canola, etc. We believe that the technology of protein supplementation of mushroom compost is mature. Efforts to reformulate protein-based supplements result in only modest improvements in mushroom yield or control of microbial growth.

There is currently an umnet need in the art of mushroom cultivation, which is satisfied by the instant invention, for a mushroom compost supplement that is able to further increase mushroom yields in an economic and cost-effective manner. The mushroom compost supplements of the present invention are based primarily on the unexpected finding that mushroom compost supplements with added polysaccharide such as, for example cellulose, increase mushroom yield without deleterious temperature surges or growth of foreign organisms during mushroom cultivation.

### SUMMARY OF THE INVENTION

It is an object of the present invention to provide a mushroom supplement to increase the yield of mushrooms in commercial mushroom production. It is a further object of this invention to provide a mushroom supplement that can be added to the compost either at spawning or up to casing. It is a further object of this invention to provide supplementary nutrients to the mushroom substrate without a resultant detrimental increase in compost temperature. It is yet another object of this invention to provide supplementary nutrients to the mushroom substrate to eliminate or minimize the need to treat the nutrients with pesticides, denaturants, heat, or other physical or chemical treatments to reduce or prevent the growth of competing microorganisms. These and other objects are met by the present invention, which comprises an improved mushroom supplement that contains substantial amounts of carbohydrates, oligosaccharides, and/or polysaccharides, including cellulose, hemicellulose, starch, gum, and materials containing substantial amounts of these components.

The most useful carbohydrates are those in which the saccharide unit is highly polymerized and resistant to attack by non-cellulolytic microorganisms. The carbohydrate-based supplement may optionally contain a fraction of a protein-based supplement formula to provide an additive effect to increase mushroom yield.

The carbohydrate-based supplement or carbohydrate-containing ingredients may be treated to increase its availability to the mushroom fungus while maintaining its recalcitrance to attack by non-cellulolytic microorganisms. The carbohydrate-based supplement is generally used at rates between about 1 and about 20 wt % (fresh weight of supplement/dry weight of compost), preferably about 1 to about 10 wt %, and most preferably about 2 to about 5 wt %.

The present invention provides an enriched mushroom compost supplement, wherein the enrichment comprises the addition of a polysaccharide or polysaccharide composition to a mushroom compost supplement.

The present invention further provides such an enriched mushroom compost wherein the enriched mushroom compost supplement provides a significantly higher mushroom yield when compared to a mushroom compost supplement lacking the enrichment.

The present invention further provides such an enriched mushroom compost wherein the polysaccharide or polysaccharide composition is selected from the group consisting of cellulose, bond paper, newsprint, straw, starch, hemicellulose, cellobiose, glycogen, trehalose and BIODAC.

The present invention further provides such an enriched mushroom compost wherein the polysaccharide or polysaccharide composition contains cellulose or cellulose-containing ingredients.

The present invention further provides such an enriched mushroom compost wherein the enriched mushroom compost supplement dampens or suppresses temperature surges during spawn run.

The present invention further provides such an enriched mushroom compost wherein the enriched mushroom compost supplement does not require additional antimicrobial or preservative treatment.

The present invention further provides such an enriched mushroom compost wherein the enriched mushroom compost supplement suppresses or reduces the growth of pest and pathogen microorganisms.

The present invention further provides such an enriched mushroom compost wherein the enriched mushroom compost supplement consists solely of polysaccharides.

The present invention further provides such an enriched mushroom compost wherein the polysaccharide or polysaccharide composition comprises from about 10% to about 20%, from about 20% to about 30%, from about 30% to about 40%, from about 40% to about 50%, from about 50% to about 60%, from about 60% to about 70%, from about 70% to about 80%, from about 80% to about 90%, or from about 90% to about 100% of the dry weight of said enriched mushroom compost supplement.

The present invention further provides such an enriched mushroom compost supplement comprising, on a dry weight basis, from about 0% to about 10%, from about 10% to about 20%, from about 20% to about 30%, from about 30% to about 40%, from about 40% to about 50%, from about 50% to about 60%, from about 60% to about 70%, from about 70% to about 80%, from about 80% to about 90%, or from about 90% to about 95% of any one of Formula 7, Formula 8, Formula 9 or Formula 10.

The present invention provides a method of increasing mushroom yield of a mushroom comprising adding an enriched mushroom compost supplement to a mushroom compost, wherein the enrichment comprises the addition of a polysaccharide or polysaccharide composition; allowing the development of mature mushrooms; and harvesting said mature mushrooms.

The present invention further provides such a method wherein the yield of the mature mushrooms is significantly increased when compared to a yield of mature mushrooms grown in the absence of the enriched mushroom compost supplement.

The present invention further provides such a method wherein the mushroom is a Basidiomycete, more particularly wherein the mushroom is a fleshy Basidiomycete.

The present invention further provides such a method wherein the mushroom is Agaricus bisporus, Lentinula edodes (formerly Lentinus edodes), Pleurotus spp., Flammulina velutipes, Stropharia rugosoannulata and/or Volvariella spp.

The present invention provides a method of supplementing a mushroom compost comprising adding an enriched mushroom compost supplement to the compost, wherein the enrichment comprises the addition of a polysaccharide or polysaccharide composition, and wherein the enriched mushroom compost supplement constitutes from about 1% to about 20% of the dry weight of said compost, more preferably about 2% to about 10% of the dry weight of said compost, and even more preferably from about 2% to about 5% of the dry weight of said compost.

The present invention provides an enriched mushroom compost supplement, wherein the polysaccharide or polysaccharide composition contains cellulose or cellulose-containing ingredients, and wherein the cellulose or cellulose-containing ingredients have been treated to increase the bioavailability of cellulose.

The present invention provides an enriched mushroom compost supplement comprising elemental sulfur.

The present invention further provides an enriched mushroom compost supplement comprising elemental sulfur, wherein the elemental sulfur comprises, on a dry weight basis, from about 0.05% to about 0.1%, from about 0.1% to about 0.15%, from about 0.15% to about 0.2%, or from about 0.2% to about 0.25% of the enriched mushroom compost supplement.

The present invention provides a method of significantly reducing mushroom compost temperatures during a spawn run comprising adding an enriched mushroom compost supplement comprising elemental sulfur to a mushroom compost, wherein the temperature of the mushroom compost is significantly reduced during the spawn run when compared to a mushroom compost lacking the enriched mushroom compost supplement comprising elemental sulfur.

The present invention further provides such a method wherein the elemental sulfur, on a dry weight basis comprises from about 0.05% to about 0.1%, from about 0.1% to about 0.15%, from about 0.15% to about 0.2%, or from about 0.2% to about 0.25% of the enriched mushroom compost supplement.

### BRIEF DESCRIPTION OF THE DRAWINGS

The foregoing summary, as well as the following detailed description of the invention, will be better understood when read in conjunction with the appended drawings. For the purpose of illustrating the invention, there are shown in the drawings embodiment(s) which are presently preferred. It should be understood, however, that the invention is not limited to the precise arrangements and instrumentalities shown.

In the drawings:

FIG. 1 shows spawn run compost temperatures for mixtures of S41 and cellulose.

FIG. 2 shows spawn run compost temperatures for supplements formulated as mixtures of SF52 and cellulose.

FIG. 3 shows the effect of starch addition on spawn run compost temperature.

FIG. 4 shows the effect of supplements made with BIODAC on spawn run compost temperatures.

### DETAILED DESCRIPTION OF THE INVENTION

Definitions

As used herein, the term “breaks” or “flushes” refers to approximately weekly bursts of mushroom fruiting bodies above ground during mushroom production.

As used herein, the term “casing” refers to a top dressing, such as, for example, moistened peat moss, which is placed over mushroom compost.

As used herein, the term “development” refers to mushroom growth including production of the fruiting body as it forms above ground.

As used herein, the term “enriched” refers to improvement of the characteristics or properties of a composition by increasing the amount of a desired component or components in the composition, wherein said component or components may be increased to comprise up to and including 100% of the composition.

As used herein, the term “mushroom beds” refers to the entire mushroom growing system, including but not limited to, for example, trays or shelves plus compost and casing (when applied).

As used herein, the term “mushroom compost” is the nutritive substrate contained within, for example, trays or shelves of a mushroom bed. Mushroom compost does not include the casing layer.

As used herein, the term “mushroom compost supplement” refers to a nutrient material or mixture of nutrient materials that is added to mushroom compost. Mushroom compost supplement may be added to mushroom compost at any time, including, for example, at spawning and at the time of casing.

As used herein, the term “polysaccharide” means any of a class of carbohydrates, such as starch and cellulose, consisting of a number of monosaccharides joined by glycosidic bonds.

As used herein, the term “polysaccharide composition” means a composition that includes any of a class of carbohydrates, such as starch and cellulose, consisting of a number of monosaccharides joined by glycosidic bonds. A polysaccharide composition may be composed entirely of two or more different polysaccharides, or it may be composed of one or more polysaccharides and anything else.

As used herein, the terms “significant” or “significantly” refer to a statistically significant increase or decrease in a measured quantity at the 0.05 confidence level.

Experimental Procedures and Results

The discovery that carbohydrate-based supplements result in improved mushroom yield is based on experimentation undertaken to define the relationship between compost components and mushroom yields. This research showed a statistically significant correlation between the total carbohydrate and cellulose contents of compost and mushroom yield, where the highest yielding composts had the highest initial cellulose level. Further, more total carbohydrate and cellulose were removed from compost than any other component. Of all compost components, we found that cellulose was the most limiting component after the completion of four “breaks” of mushroom production.

Eight mushroom growing trials were conducted in a mushroom research pilot plant in Napoleon, Ohio. In each trial, wheat straw compost was prepared according to methods known to those skilled in the art. The compost was subjected to chemical analysis at the ricking stage (beginning of Phase I), filling (end of Phase I), spawning (end of Phase II), and cook-off (end of the cropping cycle). The compost samples were analyzed for total nitrogen (Kjeldahl method), total carbohydrate, cellulose, lignin, ash, and dry matter contents essentially as described in the 14^{th} Edition of the Official Methods of Analysis of the Association of Official Analytical Chemists; herein incorporated by reference in its entirety.

The average analytical values from the eight growing trials are summarized in Table I. Because the total weight of the compost changes substantially during the composting process, analytical values based on percentage composition are not meaningful. The reduction in dry matter due to composting results in an over-estimate of percentage values. Instead, analytical values are based on pounds of analytes remaining per 1,000 lbs. of starting material.

TABLE I
Changes in compost composition during the mushroom growing process.

| | | | | | | | % CELL |
|---|---|---|---|---|---|---|---|
| | LBS. | LBS. | | | | | IN |
| | DRY | NITROGEN | LBS. | LBS. | LBS. TOTAL | LBS. | TOTAL |
| STAGE | MATTER | (KJELDAHL) | ASH | LIGNIN | CARBOHYDRATE | CELLULOSE | CHO¹ |
| RICKING | 1000 | 15.2 | 227 | 266 | 312.0 | 59.7 | 19.1% |
| FILLING | 776 | 16.2 | 207 | 209 | 170.0 | 38.6 | 22.7% |
| SPAWNING | 685 | 16.2 | 218 | 209 | 111.0 | 30.0 | 27.0% |
| COOK-OFF | 619 | 14.7 | 228 | 193 | 69.9 | 13.6 | 19.4% |

¹Percentage cellulose in total carbohydrate.

As previously known, a substantial portion of the dry matter present in the starting material is lost to microbial activity during composting. The levels of recalcitrant components (i.e., lignin) and inorganic components (i.e., ash) do not change during composting or mushroom production. Comparatively little nitrogen is lost during composting. Note that total nitrogen includes nitrogenous material included in or bound to lignin, which also is recalcitrant to microbial attack. Approximately 64% of the total carbohydrate in the starting material is lost to microbial activity between ricking and spawning, while about 50% of the cellulose is lost during the same period. The percentage of cellulose in the total carbohydrate increases between ricking and filling. This confirms that the cellulose is more recalcitrant to microbial attack than other carbohydrates present in the compost.

Between spawning and cook-off, total carbohydrate is reduced by 37% and cellulose is reduced by over 54%. The percentage of cellulose in the total carbohydrate component is reduced to 19.4%. It is clear that substantial amounts of carbohydrate are removed during composting and mushroom production. Cellulose is selectively removed between spawning and cook-off, the period in which mushrooms are produced. Our data show a high correlation (R²=0.82) between cellulose utilization after spawning and mushroom yield.

While the total carbohydrate and cellulose contents of compost are not reduced to zero, we believe that these components become limiting factors in further mushroom production. Mushrooms continue to be produced almost indefinitely, but each successive weekly “break” of production is reduced. Other researchers (Iiyama et al., 1995; Wood, 1998) have concluded that the polysaccharide content of compost is not a limiting factor in mushroom production. These researchers express polysaccharide content as a percentage rather than residual weight. We hypothesized that addition of polysaccharides, especially cellulose, would result in an increase in mushroom yield.

A series of laboratory experiments was conducted to define the effect of carbohydrates on mushroom yield. The test methods were based on a modification of the procedures of Bretzloff (1962). A series of 250 ml Erlenmeyer flasks were filled with 100 g of TURFACE brand calcined earth (8/16 mesh size). Calcined earth is a clay based material that is subject to a calcination process. The clay is heated to a temperature below its melting point to bring about a state of thermal decomposition. The calcination process results in a porous material that readily absorbs water. Depending on the particle size, calcined earth can absorb at least 100% of its weight in water. Calcined earth is commercially available under the TURFACE, OIL-DRI, and other brand names. Each flask was amended with 25 ml of a solution containing 2.6% sucrose, 2.0% DIFCO casamino acids, 0.2% DIFCO yeast extract, and 12.5 ml water, and sterilized in a steam autoclave at 121° C. for 30 min. After cooling, each flask was aseptically inoculated with two 5 mm agar plugs colonized with Agaricus bisporus strain M2. Flasks were incubated at 25° C. and periodically shaken to distribute the inoculum and growing mycelium. After 14 days incubation, the substrates were filly colonized by the mushroom mycelium. The colonized substrates were removed from the flasks, amended with various test ingredients, and placed in 16 oz. disposable plastic drinking cups. The amended substrates were cased with calcined earth plus 5% CaCO₃ to a depth of about one inch, and water was added to saturate the casing layer. Sterility is relaxed at this casing stage, since mushroom primordium development does not occur under aseptic conditions. The units were further watered and incubated under conditions known to those skilled in the art in order to induce mushroom production. Under the conditions described, experimental units with substrates that are not amended form mushroom primordia (“pins”), but those primordia do not develop into mature mushrooms. We believe that the nutrient substrate does not contain enough carbon to support the development of mature mushrooms.

We found that the addition of various polysaccharide amendments to the substrate resulted in the development of mature mushrooms. The most effective amendments include rye grain, soybean hulls, alpha cellulose, cellobiose, starch, glycogen, and trehalose. In general, the increase in mushroom production is proportional to the amount of polysaccharide added. In general, the most effective polysaccharide amendments are those that are or contain polymeric glucose, especially those in which the glucose residues are combined through alpha-1,4 or beta-1,4 linkages. Dextran, in which the glucose polymers have many branch points, appears to be less effective in supporting mushroom development. Substituted polysaccharides such as carboxymethyl cellulose are not effective in supporting mushroom development. Various homopolysaccharides (e.g. chitin) and heteropolysaccharides (e.g. gums) vary in their ability to support mushroom fruiting. We believe that polysaccharides that can release large amounts of glucose will best support fruiting. However, those that are extensively branched or that contain high proportions of residues other than glucose are less effective in supporting mushroom development.

While we do not desire to be bound by theory, the available data suggest a mechanism for the cellulose supplementation effect. Our data clearly show that the mushroom fungus Agaricus bisporus selectively removes polysaccharides from the compost substrate. A lack of available polysaccharides may become limiting to mushroom yield. The phenomenon of reduced mushroom yield with each successive “break” or “flush” of production is well known.

Abundant research has described carbohydrate metabolism during the growth and fruiting of Agaricus bisporus (for example, see Wood, 1998). It appears that the fungus maintains a balanced metabolism of carbon and nitrogen compounds during vegetative growth. That is, the Agaricus bisporus absorbs various carbon and nitrogen compounds from its substrate and the resident microbial population to build its cellular structures.

During the fruiting process, Agaricus bisporus metabolism changes dramatically. The mature mushroom contains large amounts of glycogen, polyalcohols (mannitol, etc), trehalose, and other compounds. We believe that these compounds provide the osmotic force necessary to cause water to flow into the developing mushroom and cause its expansion and maturation. Several researchers have shown that Agaricus bisporus releases cellulolytic enzymes into the substrate during the fruiting process (for example, see Wood, 1998). These enzymes would liberate glucose and other saccharides from the polysaccharide substrate from which to generate the polyalcohols and other compounds necessary for fruiting.

We hypothesize that virtually any carbohydrate would provide the carbon necessary to support Agaricus bisporus fruiting. However, cellulose is probably the ideal material. The beta-1,4 linkage between the glucose units makes this polysaccharide recalcitrant to attack by compost microorganisms and most pests and pathogens. Readily available carbohydrates are depleted during compost preparation and spawn run and would not be available to support mushroom development.

This hypothesis is supported by the observation that many monosaccharides and disaccharides are only marginally effective in supporting mushroom development in the test system described above. When added to the substrate prior to the vegetative growth phase (equivalent to spawn run), only slight mushroom development occurs. We believe that the simple sugars are used vegetatively and are no longer available to Agaricus bisporus during the fruiting stage. However, monosaccharides and disaccharides injected into the substrate at the time that mushroom primordia develop do support fruiting.

Mushroom strains contemplated for use with the enriched mushroom compost supplements of the invention include but are not limited to: Agaricus bisporus, Agaricus bitorquis, Agrocybe aegerita, Amanita spp., Armillaria mellea, Auricularia spp., Boletus spp., Cantharellus cibarius, Collybia fusipes, Coprinus spp., Flammulina velutipes, Ganoderma lucidum, Grifola frondosa, Hericium erinaceus, Hydnum repandum, Hypsizygus marmoreus, Kuehneromyces mutabilis, Lactarius spp., Lentinula edodes, (formerly Lentinus edodes), Lepiota spp., Lyophyllum georgii, Marasmius oreades, Morchella spp., Pleurotus spp., Pholiota spp., Plicaria muralis, Psalliota spp., Rhodopaxillus spp., Russula virescens, Stropharia rugoso-annulata, Tremella fuciformis, Tricholoma matsutake, Tuber spp., Volvariella spp., and Peziza aurantia.

Unless defined otherwise, all technical and scientific terms herein have the same meaning as commonly understood by one of ordinary skill in the art to which this invention belongs. Although any methods and materials, similar or equivalent to those described herein, can be used in the practice or testing of the present invention, the preferred methods and materials are described herein. All publications cited herein are incorporated herein by reference for the purpose of disclosing and describing specific aspects of the invention for which the publication is cited.

Without further description, it is believed that a person of ordinary skill in the art can, using the preceding description and the following illustrative examples, make and utilize the present invention and practice the disclosed methods. The following working examples therefore, specifically point out the preferred embodiments of the present invention, and are not to be construed as limiting in any way the remainder of the disclosure.

### EXAMPLE 1

### Mushroom Yield Enhancement Due to Cellulose

An initial test of a carbohydrate-based supplement was conducted in a mushroom research pilot plant in Napoleon, Ohio. Wheat straw/horse manure blend compost was obtained from the Brighton Mushroom Farm at Howe, Ind. at the completion of the Phase II process. Compost (16 lbs. dry weight) was filled into each of 48-2 ft×2 ft wooden trays. Each tray was amended with Agaricus bisporus strain M8 mushroom spawn at a rate of 3% (fresh weight spawn to dry weight of compost) and S41 supplement (see Formula 7, Table IX) at a rate of 4% (fresh weight supplement to dry weight compost). Trays from each treatment (8 replicates per treatment) were amended with the percentage of cellulose indicated in Table II (dry weight cellulose to dry weight compost). The cellulose source was SOLKA-FLOC grade KS-1016 alpha cellulose obtained from the James River Corporation, Berlin, N.H. SOLKA-FLOC is pure cellulose or a glucose polymer joined through beta-1,4 linkages. The cellulose was lightly moistened after weighing and before addition to the compost to reduce airborne dust. Trays were covered with plastic and incubated at ca. 25° C. for 10 days. Each tray was cased with a mixture of peat moss and agricultural lime, and treated according to methods known to those skilled in the art to produce mushrooms. The mushroom yield is summarized in Table II.

TABLE II
Effect of cellulose supplementation on mushroom yield.

| | | 1^{ST} | | | |
|---|---|---|---|---|---|
| | % | BREAK | 2^{ND} BREAK | 3^{RD} BREAK | TOTAL |
| TRT # | CELLULOSE | LB/FT² | LB/FT² | LB/FT² | YIELD |
| 1 | 0 | 1.42 | 1.65 | 0.69 | 3.76 |
| 2 | 1 | 1.51 | 1.73 | 0.62 | 3.86 |
| 3 | 2 | 1.60 | 1.72 | 0.60 | 3.92 |
| 4 | 3 | 1.56 | 1.71 | 0.64 | 3.91 |
| 5 | 4 | 1.60 | 1.78 | 0.58 | 3.96 |
| 6 | 5 | 1.61 | 1.82 | 0.60 | 4.03 |

The yield increases associated with cellulose supplementation are proportional to the amount of cellulose added. The yield increase attributable to the cellulose supplementation at the 5% rate is 0.27 lb/ft² (7.18%). The most cost-efficient cellulose supplementation rate in this test is about 2 to 3%, although this value varies among different experiments.

Supplementation with purified alpha cellulose clearly increases mushroom yield. However, this strategy suffers from several disadvantages. Purified cellulose is expensive. The powdery texture and low density of the alpha cellulose make it inconvenient to handle. There is a concern that the low water content of the cellulose draws moisture from the compost and could compromise yield increases. The following experiment was conducted to address some of these issues:

### EXAMPLE 2

### Yield Enhancement/Effect of Pelleting and Moistening

SOLKA-FLOC grade KS-1016 alpha cellulose was obtained as described previously. The material was amended with 0.1% Agri-Gum pelleting aid, adjusted to 15% moisture and pelleted in a pilot scale pellet mill with a 0.125″×1″ die. The pelleted material was used as produced or amended with an equal weight of water. The cellulose was added to mushroom compost essentially as described previously at the rates described in Table III. Experimental treatments also included compost with no cellulose added and compost amended with unpelleted cellulose that had been adjusted to ca. 65% moisture. All compost was supplemented with 4% S41 supplement (see formula 7, Table IX) and inoculated with 3% Agaricus bisporus strain M8 spawn. The mushroom yield from this trial is shown in Table III.

TABLE III
Effect of cellulose pelleting and moistening on mushroom yield.

| TRT | | 1^{ST} BREAK | 2^{ND} BREAK | 3^{RD} BREAK | TOTAL | |
|---|---|---|---|---|---|---|
| # | TREATMENT | LB/FT² | LB/FT² | LB/FT² | YIELD* | |
| 1 | NO CELLULOSE | 1.24 | 0.58 | 0.48 | 2.51 | C |
| 2 | 5% PELLETS - DRY | 1.19 | 0.48 | 0.43 | 2.54 | BC |
| 3 | 5% PELLETS - WET | 0.99 | 0.73 | 0.73 | 2.82 | ABC |
| 4 | 10% PELLETS - WET | 1.42 | 0.69 | 0.63 | 3.07 | A |
| 5 | 15% PELLETS - WET | 1.33 | 0.91 | 0.53 | 2.92 | ABC |
| 6 | 5% POWDER - WET | 1.25 | 0.76 | 0.71 | 3.02 | AB |

*Total mushrooms yields with the same letter are not statistically different at the 0.05 confidence level.

In this test, dry cellulose added at 5% of the total compost dry weight gave a marginal increase in mushroom yield. The mushroom supplementation effect generally is variable. The maximum yield increase in this experiment was seen with Treatment 4. This showed a 0.56 lb/ft² (22.3%) increase in yield. There appears to be no detriment to mushroom yield increases due to pelleting of the alpha-cellulose powder. Further, moistening the alpha-cellulose pellets or powder to about 65% moisture appears to sustain the yield increases associated with alpha-cellulose supplementation. Pelleting and/or moistening of the alpha-cellulose improves its handling characteristics by reducing the volume of the supplement and by reducing the amount of dust released while mixing the supplement into the compost. Moistening of the alpha cellulose supplement may improve its performance by reducing the amount of moisture drawn away from the compost.

### EXAMPLE 3

### Additive Effect of Alpha-Cellulose and Protein Supplements

In order to determine the relationship of the supplement effect afforded by alpha-cellulose and by existing protein-based supplements, a test was designed with and without cellulose and with and without S41 supplement (see formula 7, Table IX). S41 supplement consists of a cracked, full-fat soybean particle coated with a mold-inhibiting composition, essentially as described in U.S. Pat. No. 4,617,047 (which is hereby incorporated by reference in its entirety). The test was essentially as described above, except that each treatment consisted of four 4 ft×3 ft wooden trays filled with 5 lb. dry weight of compost per square foot of tray area. The S41 supplement was added at 4% of the dry weight of the compost, and the alpha-cellulose (as described above) was added at 5% of the dry weight of the compost. The alpha cellulose was in powdered form and adjusted to 50% moisture with tap water. The results of this trial are summarized in Table IV.

TABLE IV
Additive effect of alpha cellulose and protein supplements.

| | | % | 1^{ST} BREAK | 2^{ND} BREAK | 3^{RD} BREAK | TOTAL | |
|---|---|---|---|---|---|---|---|
| TRT # | % S41 | CELLULOSE | LB/FT² | LB/FT² | LB/FT² | YIELD* | |
| 1 | 0 | 0 | 1.84 | 1.86 | 0.81 | 4.51 | C |
| 2 | 4 | 0 | 2.21 | 1.91 | 0.95 | 5.07 | B |
| 3 | 0 | 5 | 2.04 | 1.87 | 0.96 | 4.87 | B |
| 4 | 4 | 5 | 2.46 | 2.24 | 1.09 | 5.79 | A |

*Total mushrooms yields with the same letter are not statistically different at the 0.05 confidence level.

S41 and alpha cellulose each result in a statistically significant increase in mushroom yield. The yield increase attributable to S41 was 0.56 lb/ft² (12.4%). The yield increase attributable to alpha-cellulose was 0.36 lb/ft² (8.0%). Addition of both 4% S41 5% and alpha-cellulose resulted in a 1.28 lb/ft² (28.4%) increase in mushroom yield. This is clearly an additive effect.

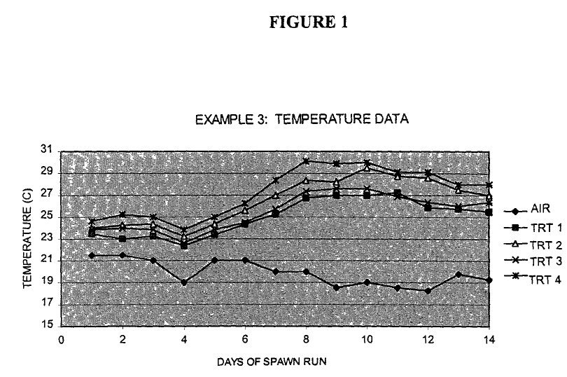

Compost temperatures were monitored throughout the spawn run period of this test. Temperature data are summarized in FIG. 1. Compost containing no additives (Treatment 1) does not show a substantial temperature increase during spawn run. The maximum compost temperature is approximately 27° C. (81° F.). Compost supplemented with 5% moistened alpha-cellulose (Treatment 3) also fails to show a major increase in temperature. A traditional protein-based supplement (Treatment 2; 4% S41) shows a major temperature surge, with a peak temperature of about 29.5 C (85° F.) at about 10 days after spawning. Compost supplemented with both 4% S41 and 5% moistened alpha-cellulose (Treatment 4) showed a maximum compost temperature of about 30.5° C. (87° F.) about 8 to 10 days after spawning. Temperatures above about 30° C. (86° F.) are known to be detrimental to mushroom yield. A supplement capable of increasing mushroom yield without causing high compost temperatures is clearly an advantage. In addition, a supplement that avoids temperature increases reduces the energy and capital equipment costs necessary to prevent compost overheating.

### EXAMPLE 4

### Mixtures of Cellulose and Proteinaceous Ingredients

In order to minimize the number of separate products used on mushroom farms, tests were conducted to determine whether cellulose and protein-containing supplements could be formulated as a single product. Supplement SF52 is a product of Money's Foods, U.S., Inc., and consists of finely ground soybeans treated with an antimicrobial coating (see Formula 9, Table IX). SF52 was mixed with varying amounts of alpha-cellulose as shown in Table V. The supplement formulations were added to compost to maintain a constant rate of 1% supplement SF52 and 1 to 3% rates of alpha cellulose in the compost. The compost was filled into 4 ft×3 ft trays according to standard methods essentially as described previously. The results of this trial are summarized in Table V.

TABLE V
Mixtures of alpha cellulose and SF52 supplement.

| | | % | 1^{ST} BREAK | 2^{ND} BREAK | 3^{RD} BREAK | TOTAL | |
|---|---|---|---|---|---|---|---|
| TRT # | % SF52 | CELLULOSE | LB/FT² | LB/FT² | LB/FT² | YIELD* | |
| 1 | 1 | 0 | 2.99 | 2.76 | 0.88 | 6.63 | B |
| 2 | 1 | 1 | 2.99 | 3.09 | 0.93 | 7.01 | A |
| 3 | 1 | 3 | 3.07 | 2.98 | 0.95 | 6.99 | A |

*Total mushrooms yields with the same letter are not statistically different at the 0.05 confidence level.

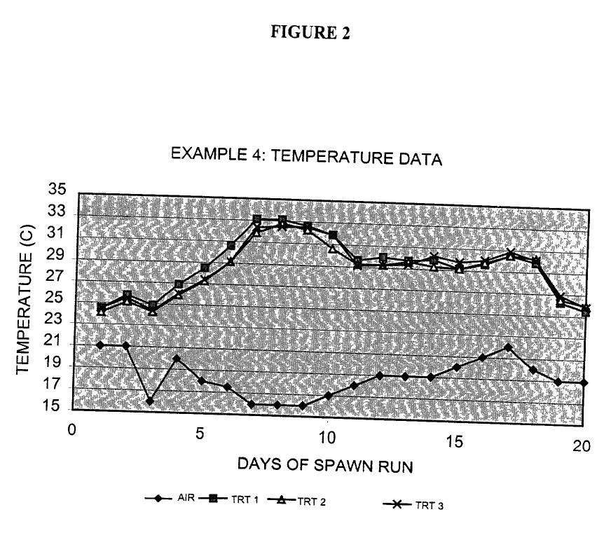

Mixtures of alpha cellulose and SF52 supplement gave significantly higher mushroom yields than SF52 alone. This experiment also demonstrates that mixtures of the ingredients are as effective as when the components are added to compost separately. Compost temperature data are summarized in FIG. 2. Since the amount of SF52 supplement added was constant and the alpha cellulose does not contribute to compost temperatures surges, all compost temperatures were similar during spawn run. The observation that 1% SF52 alone gives slightly higher compost temperatures than mixtures of SF52 and alpha-cellulose indicates that cellulose dampens compost temperature surges during spawn run.

### EXAMPLE 5

### Other Polysaccharides as Supplement Components

As noted previously, we hypothesize that virtually any carbohydrate would provide the carbon necessary to support Agaricus bisporus fruiting. Cellulose is probably the ideal material. The beta-1,4 linkage between the glucose units makes this polysaccharide recalcitrant to attack by compost microorganisms and most pests and pathogens. Readily available carbohydrates would be at least partially depleted during compost preparation and spawn run and would not be available to support mushroom development. In order to test this hypothesis, a supplement was formulated with corn starch as a component. The alpha-1,4 linkage of starch would be subject to attack by many organisms, including those present in compost.

In order to assess the effectiveness of polysaccharides other than cellulose, four experimental supplements were formulated as pellets. Treatment 1 consisted of a mixture of 80% alpha-cellulose (as described above) and 20% soybean fines. The soybean fines consist of small fragments of full fat soybeans, dust, and other materials that are removed during the soybean cleaning and sizing processes. Treatment 2 consisted of a mixture of 60% alpha-cellulose, 20% soybean fines, and 20% corn starch. Treatment 3 consisted of 40% alpha-cellulose, 20% soybean fines, and 40% corn starch. Treatment 4 consisted of 60% alpha-cellulose, 20% soybean fines, and 20% corn starch plus 0.1% elemental sulfur to control microbial growth. All supplements were pelleted through a 0.125″×1″ pellet mill die. Each supplement was added to compost at 5% of the dry weight of the compost in 4 ft×3 ft trays containing 5 lb. compost per square foot. All treatments were also amended with S41 supplement at 3% of the dry weight of the compost. Compost temperature was monitored throughout the spawn run of this trial using an automated data acquisition system. Yield data for this experiment are summarized in Table VI:

TABLE VI
Effect of starch addition to cellulose supplement on mushroom yield.

| TRT | | 1^{ST} BREAK | 2^{ND} BREAK | 3^{RD} BREAK | TOTAL | |
|---|---|---|---|---|---|---|
| # | DESCRIPTION* | LB/FT² | LB/FT² | LB/FT² | YIELD** | |
| 1 | CELL:SBF (4:1) | 2.46 | 1.39 | 0.97 | 4.82 | B |
| 2 | CELL:SBF:ST (3:1:1) | 2.55 | 1.54 | 1.17 | 5.26 | A |
| 3 | CELL:SBF:ST (2:1:2) | 2.67 | 1.45 | 1.18 | 5.30 | A |
| 4 | CELL:SBF:ST (3:1:1) + 0.1% S | 2.84 | 1.43 | 1.21 | 5.48 | A |

*“CELL” = alpha-cellulose; “SBF” = soybean fines; “ST” = corn starch; “S” = elemental sulfur.
**Total mushrooms yields with the same letter are not statistically different at the 0.05 confidence level.

All supplements formulated with corn starch showed significantly higher mushroom yields than supplements without starch. This confirms that the starch supports increased mushroom production.

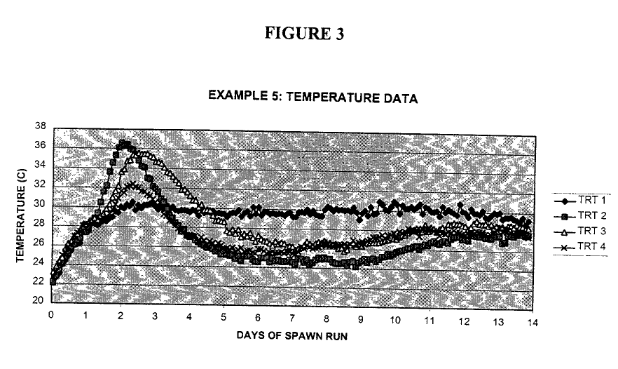

Temperature data for this trial are summarized in FIG. 3. All supplements formulated with corn starch showed extremely high compost temperatures. This is consistent with our belief that some of the starch would be subject to attack by compost microorganisms. Treatment 2 showed a maximum compost temperature of about 37° C. (99° F.) about 2 days after spawning. Treatment 3 showed a maximum compost temperature of over 35° C. (95° F.) about 3 days after spawning. Both of these treatments showed increased mushroom yields despite the dangerously high temperatures. Addition of 0.1% sulfur to the cellulose: soybean fine: starch (3:1:1) pellet helped to control the temperature surge and resulted in a further increase in mushroom yield. Our data show that sulfur is an effective coating treatment to minimize high compost temperatures associated with the addition of supplements to compost.

The effectiveness of any polysaccharide material as a supplement can be readily determined by routine experimentation by those skilled in the art. We believe that many factors affect the ability of a polysaccharide to increase mushroom yield. These include the fraction of recalcitrant polysaccharide (i.e., cellulose or other material containing beta-1,4 glycoside linkages), the fraction of readily available polysaccharide (starch or other materials containing the alpha-1,4 linkages), the amount of monosaccharides and oligosaccharides, and the presence of other materials in the ingredient. For example, ingredients containing protein may contribute to compost heating and mold growth unless the ingredients are treated to prevent microbial growth.

### EXAMPLE 6

### Polysaccharide-Containing Ingredients

Previous tests evaluated the use of highly purified alpha cellulose. While effective, purified cellulose is expensive. The need to moisten and/or pellet the cellulose to improve handling and reduce airborne dust also is a disadvantage.

We have extensively evaluated “BIODAC” as an inexpensive source of cellulose. BIODAC is a registered trademark of Grantek Inc., Green Bay, Wis. The product sold under the trademark BIODAC is composed of approximately 50% paper fiber, plus kaolin, CaCO₃ and Titanium Dioxide. It is formulated as a ca. 1-2 mm diameter sphere and is substantially free of dust. BIODAC is typically used as a carrier for agricultural pesticides. BIODAC contains no components that would contribute to the growth of pests and pathogens or to compost heating. A typical test of supplements formulated with BIODAC is summarized below.

Four supplements were formulated for this experiment. Treatment 1 consists of SF52 supplement (see formula 9, Table IX). Treatment 2 consists of a supplement consisting of 20% ground soybeans, 30% feather meal, and 50% BIODAC. The supplement components were mixed well and preserved with 2% (wt/wt) propylene glycol, and 0.4% thiabendazole. The supplement was mixed well to distribute the preservative. Treatment 3 consists of a mixture of 40% ground soybeans and 60% feather meal. These components were mixed well and treated with the same preservative as was used for Treatment 2 (wt/wt). The mixture was then combined with an equal weight of BIODAC and mixed well. For this treatment, only the protein component of the supplement received the preservative coating. Treatment 4 consists of SF52 supplement (see formula 9, Table IX) mixed with an equal weight of BIODAC. Again in this treatment, only the protein component of the supplement received the preservative coating. Each supplement was added to compost at 2% of the dry weight of the compost in 4 ft×3 ft trays containing 6 lb. (dry weight) compost per square foot. No other supplements were added to the compost. The compost was spawned at a 3% rate with Agaricus bisporus strain M470 and treated as described previously to produce mushrooms. Compost temperature was monitored throughout the spawn run of this trial. Yield data for this experiment are summarized in Table VII:

TABLE VII
Effect of BIODAC supplementation on mushroom yield.

| TRT | | 1^{ST} BREAK | 2^{ND} BREAK | 3^{RD} BREAK | TOTAL | |
|---|---|---|---|---|---|---|
| # | DESCRIPTION* | LB/FT² | LB/FT² | LB/FT² | YIELD** | |
| 1 | SF52 | 2.58 | 2.58 | 1.18 | 6.33 | B |
| 2 | 20% GSB, 30% FM, 50% | 2.68 | 2.71 | 1.29 | 6.68 | AB |
| | BIODAC (ALL COATED) | | | | | |
| 3 | 20% GSB, 30% FM, 50% | 2.85 | 2.77 | 1.27 | 6.88 | A |
| | BIODAC (PROTEIN COATED) | | | | | |
| 4 | 50% GSB, 50% BIODAC | 2.70 | 2.59 | 1.23 | 6.51 | AB |
| | (PROTEIN COATED) | | | | | |

*“SF52” = SF52 supplement as described in formula 9. “GSB” = ground soybeans. FM = feather meal. BIODAC = BIODAC, a product of Grantek Inc., Green Bay, WI.
**Total mushrooms yields with the same letter are not statistically different at the 0.05 confidence level.

All supplements formulated with BIODAC support increased mushroom yields compared with SF52 alone. While the yield increases for Treatments 2 and 4 are not statistically significant, yield increases are 0.35 lb/ft² and 0.18 lb/ft², respectively. Treatment 3 gives a statistically significant yield increase of 0.55 lb/ft² compared with SF52 alone.

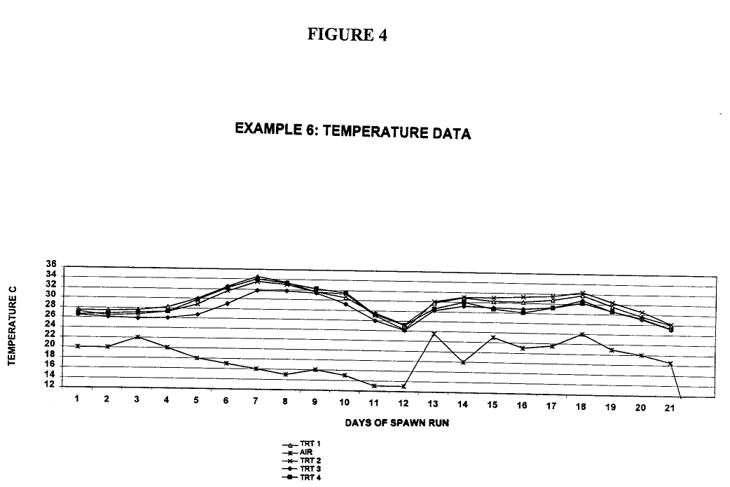

Temperature data for this trial are summarized in FIG. 4. Treatments 1, 2, and 4 all show similar temperature profiles. Unexpectedly, spawn run compost temperatures for Treatment 3 were consistently lower than for the other treatments. This is particularly significant since Treatment 3 gave the highest yield. The fact that only the protein component of the supplement receives the preservative coating also makes this formulation the most economically feasible supplement formula.

We conclude that BIODAC is an effective source of cellulose to support mushroom yield increases.

Other polysaccharide-containing ingredients for use as enriching components in a mushroom compost supplement are contemplated to be within the scope of the present invention. We believe that many factors affect the ability of a polysaccharide-containing ingredient to increase mushroom yield. These include the fraction of recalcitrant polysaccharide (i.e., cellulose or other material containing beta-1,4 glycoside linkages), the fraction of readily available polysaccharide (starch or other materials containing the alpha-1,4 linkages), the amount of monosaccharides and oligosaccharides, and the presence of other materials in the ingredient. For example, ingredients containing protein may contribute to compost heating and mold growth unless the ingredients are treated to prevent microbial growth.

Other polysaccharides or polysaccharide compositions containing cellulose that are contemplated for use in the enriched mushroom compost supplements of the invention include but are not limited to: Agar, Cellobiose, Chitin, Chitosan, Cloth and cloth byproducts, Corn, Corn cobs, Corn starch, Cotton and cotton waste products, Dextrin, Fruit skins, Carrageenan, Glycogen, Hemicellulose, Inulin, Mannose, Natural gums, Paper and paper byproducts, Pectin, Plant exudates, Purified cellulose (i.e., alpha cellulose, microcrystalline cellulose, etc.), Rice wheat, Seaweed extracts, Seed hulls or seed coverings, Seed gums, Starch, Straw, Sugarbeet pulp, Trehalose, Wood (especially hardwood) and wood byproducts (sawdust, chips, pulp, etc.), Woody fibers and leaves, Xylan and BIODAC.

### EXAMPLE 7

### Treatment of Cellulosic and Lignocellulosic Ingredients to Increase Availability

Many researchers have related the physical and chemical structures of lignocellulosic materials to their ability to be degraded by microorganisms (for example, see Kirk, 1983; Tsao & Chiang, 1983; Gould, 1985). As noted by Kirk (1983), the susceptibility of cellulose to microbial degradation is dependent upon its capillary structure, degree of crystallinity, dimensions of the crystalline portions, and the presence of other substances, especially lignin. Treatments that alter the structure of the lignocellulose complex may increase the availability of the cellulose to degradation. Tsao & Chiang (1983) summarize several treatments known to increase cellulose availability.

We believe that treatments that increase the availability of cellulose or cellulose-containing materials to microbial degradation render a polysaccharide substrate more suitable for increasing mushroom yield. The following experiment demonstrates the effect of increasing cellulose availability on mushroom yield.

A series of 100 ml Erlenmeyer flasks were filled with 100 g of calcined earth and a nutrient solution as described previously. The flasks were sterilized, inoculated with Agaricus bisporus strain M2, and incubated to allow the growth of mycelium. The colonized substrates were transferred to 16 oz. plastic cups and amended as follows: Ten substrates were not amended. Ten substrates were amended with 3% (w/w) alpha-cellulose as described previously. Ten substrates were amended with 3% (w/w) wheat straw treated with an alkaline peroxide solution prepared essentially as described by Gould (U.S. Pat. No. 4,997,488 (which is hereby incorporated by reference in its entirety)). Gould (1985) has shown that this treatment removes significant amounts of lignin from lignocellulosic materials and results in a material that is highly susceptible to cellulase enzymes. The substrates were cased as described previously and treated to allow mushroom development. The average mushroom yield per substrate that successfully fruited is summarized in Table VIII.

TABLE VIII
Effect of pretreatment of lignocellulosic substrate on mushroom
yield.

| | | AVERAGE YIELD | % CONVERSION |
|---|---|---|---|
| TRT # | ADDITIVE* | PER CUP (G) | OF ADDITIVE |
| 1 | NO ADDITIVE | 0.0 | 0 |
| 2 | 3% alpha- | 3.70 | 123 |
| | CELLULOSE | | |
| 3 | 3% APWS | 7.22 | 240 |

*“APWS” is alkaline peroxide treated wheat straw essentially as described by U.S. Pat. No. 4,649,113 (which is hereby incorporated by reference in its entirety) and Gould (1985).

Ground wheat straw is generally only slightly effective in supporting mushroom yield. It is difficult to demonstrate the effect of untreated ground wheat straw in this test system since it often results in mold contamination. In this test, alpha-cellulose supported the production of 1.23 g of mushrooms (fresh weight) per g (dry weight) of material added. Alkaline peroxide treated wheat straw supported the production of 2.4 g (fresh weight) of mushrooms per g (dry weight) of material added. We attribute the higher mushroom yield to the increased availability of the cellulose substrate. We believe that other treatments known to increase the susceptibility of lignocellulosic substrates to attack by cellulase enzymes (see Tsao & Chiang, 1983) are equally effective in making the materials more suitable as mushroom supplements.

### EXAMPLE 8

The following are examples of formulas for mushroom supplements formulated with carbohydrates, carbohydrate-containing ingredients, carbohydrate and carbohydrate-containing ingredients treated to increase the availability of the ingredients, and mixtures of carbohydrates and protein-containing ingredients.

TABLE IX
Mushroom Compost Supplement Materials

| | |
|---|---|
| Formula | Ingredients |

| Formula 1 | Purified Cellulose (such as SOLKA-FLOC | |
|---|---|---|
| | grade KS-1016 alpha-Cellulose) | |
| Formula 2 | Shredded bond paper | 100% |
| Formula 3 | Shredded newsprint | 100% |
| Formula 4¹ | Acid-Swollen Cellulose | 100% |
| Formula 5² | Alkaline Peroxide Wheat Straw | 100% |
| Formula 6³ | BIODAC | 100% |
| Formula 7⁴ | Cracked Soybeans | 97.8% |
| | Undecylenic Acid | 2.0% |
| | Thiabendazole | 0.2% |
| Formula 8⁵ | Cracked Soybeans | 97.8% |
| | Propylene Glycol | 2.0% |
| | Thiabendazole | 0.2% |
| Formula 9⁶ | Ground Soybeans | 97.6% |
| | Propylene Glycol | 2.0% |
| | Thiabendazole | 0.4% |
| Formula 10⁷ | Ground soybeans | 38.8% |
| | Feather meal | 58.8% |
| | Propylene Glycol | 2.0% |
| | Thiabendazole | 0.4% |
| ¹Cellulose (such as in formulas 1, 2, or 3) is pre-treated with phosphoric acid essentially as described by Tsao & Chiang, 1983. | | |
| ²Wheat straw is treated with hydrogen peroxide under alkaline conditions essentially as described by U.S. Pat. No. 4,997,488 (which is herein incorporated by reference in its entirety). | | |
| ³BIODAC is a product of Grantek Inc., Green Bay, WI | | |
| ⁴Soybeans are cleaned of hulls, dust, and foreign matter, and cracked to an average particle size of 30 mg. The cracked soybeans are placed in a coating drum and a mixture of undecylenic acid and thiabendazole is sprayed onto the surface of the cracked soybeans to provide an even distribution | | |
| # of the mixture. The cracked soybeans optionally may be pre-treated at 165° F. for 90 seconds to prevent sprouting of any soybean germ that may have survived the cracking process. | | |
| ⁵Soybeans are cleaned of hulls, dust, and foreign matter, and cracked to an average particle size of 30 mg. The ground soybeans are placed in a coating drum and a mixture of propylene glycol and thiabendazole is sprayed onto the surface of the cracked soybeans to provide an even distribution | | |
| # of the mixture. The cracked soybeans optionally may be pre-treated at 165° F. for 90 seconds to prevent sprouting of any soybean germ that may have survived the cracking process. | | |
| ⁶Soybeans are cleaned of hulls, dust, and foreign matter, and ground to a fine powder. The ground soybeans are placed in a coating drum and a mixture of propylene glycol and thiabendazole is sprayed onto the surface of the ground soybeans to provide an even distribution of the mixture. | | |
| # The ground soybeans optionally may be pre-treated at 165° F. for 90 seconds minutes to prevent sprouting of any soybean germ that may have survived the grinding process. | | |
| ⁷Soybeans are cleaned of hulls, dust, and foreign matter, and ground to a fine powder. The ground soybeans and feather meal are placed in a coating drum and a mixture of undecylenic acid and thiabendazole are sprayed onto the surface of the ground soybeans to provide an even distribution | | |
| # of the mixture. The ground soybeans and feather meal optionally may be pre-treated at 165° F. for 90 seconds to prevent sprouting of any soybean germ that may have survived the grinding process. | | |

Use of Carbohydrate-Containing Mushroom Supplement: In a bed-type mushroom operation, the supplement is spread on the surface of mushroom compost at the completion of the Phase II process. The usage rate is typically 2-3 wt % (fresh weight of supplement/dry weight compost), but the optimum rate may be higher or lower, depending on the dry weight of compost filled and the environmental capabilities of the farm. Mushroom spawn and other additives also are layered on the surface of the compost. All additives are mixed with compost according to usual procedures. In the case of a tray-type mushroom operation, the supplement is added to a hopper over the spawning line and metered into the compost at about the same time as mushroom spawn. Compost is returned to trays and compressed. In the case of a “Dutch-Style” Tunnel operation, the supplement is added at spawning or casing according to usual procedures. In all cases, mushroom cultivation otherwise proceeds according to usual procedures.

### EXAMPLE 9

### Addition of Polysaccharides Prior to Spawning

Since cellulose is recalcitrant to microbial attack during Phase I and Phase II composting (see Table II), addition of polysaccharide to compost prior to spawning results in increased mushroom yield. Essentially any treatment that provides a higher polysaccharide content in the compost during mushroom maturation will result in higher productivity.

There are limits to the amount of polysaccharide that can be added prior to spawning. If added too early in the process, the “supplement” would actually be a compost ingredient. More importantly, adding polysaccharide-containing ingredients early in the composting process would likely result in deleterious effects. Compost formulas at the beginning of the process typically contain about 1.4 to 1.5% nitrogen (Hayes, 1978; Fermor et al., 1985). As composting proceeds, a substantial portion of the readily available carbohydrate is metabolized by compost microorganisms. Carbon to nitrogen ratios are typically about 20:1 to 22:1 at the beginning of Phase II and about 14:1 to 17:1 at the spawning stage. This results in nitrogen contents of about 2.3 to 2.4% at spawning. Addition of crude polysaccharide sources (such as wheat straw) contribute additional readily available carbohydrate. This results in significant changes in compost characteristics at spawning. Most importantly, the readily available carbohydrates added late in the composting process causes high compost temperatures during spawn run. The available carbohydrates also contribute to mold growth.

In contrast, the addition to compost of polysaccharides that are substantially free of readily available carbohydrates avoids changes in the composting process. The ideal polysaccharide additives are those that are essentially pure cellulose or other recalcitrant polysaccharide.

In order to test this hypothesis, the following experiment is initiated at a commercial tray-type mushroom farm. Phase I compost based on a wheat straw and horse manure formula is prepared according to methods known by those skilled in the art of growing mushrooms. At the completion of Phase I, the compost is filled into 4′×6′ wooden trays at approximately 7.5 to 8 lbs. dry weight compost per square foot of tray area according to standard procedures. The compost is either unamended (Treatment 1), amended with BIODAC (see Formula 6; Treatment 2), amended with shredded white 20 lb. photocopier paper (Treatment 3), or amended with shredded newsprint (Treatment 4). All amendments are added at a rate of 5% dry weight additive to dry weight of the compost. The photocopier paper may be recycled office paper. No attempt is made to remove or avoid printer ink. Shredded newsprint largely may be from commercially available recycled newspaper. No attempt is made to avoid or remove ink. Only white newsprint is used. Tinted and rotogravure pages are removed. Amendments are mixed with compost during the standard filling operations. Compost samples are removed from each tray for analysis. The compost is subjected to a standard nine day Phase II process known to those skilled in the art of growing mushrooms. At the completion of the process, the compost is shipped to a mushroom research facility for further testing.

The control (Treatment 1) and amended composts are sampled for chemical analysis, spawned with Agaricus bisporus strain M470 spawn at a 3% spawning rate, and filled into 3×4′ wooden trays at 6 lb. dry matter of compost per square foot of tray area. Each tray is treated to produce mushrooms according to methods known by those skilled in the art.

Compost samples at filling, spawning, casing, and the completion of the mushroom growing process are analyzed for carbon, nitrogen, ash, total carbohydrate and total cellulose by methods known to those skilled in the art. The amendments result in the predicted increase in the total carbohydrate and cellulose contents of the compost. Approximately 7% of the polysaccharide additive is lost to microbial activity during Phase II.

Each of the amendments result in a substantial increase in mushroom yield. We attribute the yield increases to the increased polysaccharide contents of the compost samples.

The yield increase is attributed to the addition of shredded newsprint to the compost. Newsprint is typically considered to be somewhat recalcitrant to microbial attack because of its lignin content. However, the high temperature, high pH, and oxidizing conditions may result in delignification of the newsprint, thus making the cellulose more available to the mushroom fungus. High pH in an oxidizing environment is known to cause an irreversible delignification of lignocellulosic materials (Gould, 1985).

Polysaccharides that are substantially free of readily available carbohydrates can be added at virtually any time during the Phase I and Phase II processes. The specific rate and time of addition are determined by routine experimentation. The optimum rate and time of addition are interdependent. Since a portion of the polysaccharide is lost during composting, an earlier addition to the compost requires a higher rate of addition to achieve the same effect as a later addition of a lower rate. At some time and rate combinations, the supplementation may lose its economic advantage.

### REFERENCES

Bretzloff, C. W. 1962. A quantitative method for the study of mushroom nutrition in the laboratory. Mushroom Science 5:241-246.

Chang, S. T. & W. A. Hayes, Eds. 1978. The Biology and Cultivation of Edible Mushrooms. Academic Press, NY. 819 pages.

Chang, S. T. & P. G. Miles. 1989. Edible Mushrooms and their Cultivation. CRC Press. Boca Raton. 345 pages.

Fermor, T. R., P. E. Randle & J. F. Smith. 1985. Compost as a substrate and its preparation. Chapter 6, Pages 81-109, In: The Biology and Technology of the Cultivated Mushroom. P. B. Flegg, D. M. Spencer & D. A. Wood, Eds. John Wiley & Sons, Ltd., Chichester. (This is a chapter in Flegg et al.)

Flegg, P. B., D. M. Spencer & D. A. Wood, Eds. 1985. The Biology and Technology of Cultivated Mushrooms. John Wiley & Sons, Ltd. Chichester. 347 pages.

Gould, J. M. 1985. Studies on the mechanism of alkaline peroxide delignification of agricultural residues. Biotechnol. Bioeng. 27: 225-231.

Hayes, W. A. 1978. Nutrition, substrates, and principles of disease control. Chapter 9, Pages 219-237, In: The Biology and Technology of Cultivated Mushrooms. S. T. Chang & W. A. Hayes, Eds. Academic Press, New York.

Iiyama, K., T. B. T. Lam, B. A. Stone, P. S. Perrin & B. J. Macauley. 1995. Compositional changes in composts during various types of composting and mushroom growth. Pages 235-244, In: T. J. Elliott. Science & Cultivation of Edible Fungi. A. A. Balkema. Rotterdam.

Kirk, T. K. 1983. Degradation and Conversion of Lignocellulosics. Chapter 11 (Pages 266-295, In: The Filamentous Fungi. Volume 4. Fungal Technology. Edward Arnold. London.

National Academy of Sciences. 1971. Atlas of Nutritional Data on United States and Canadian Feeds. National Academy of Sciences. Washington, D. C. 772 pages.

Official Methods of Analysis of the Association of Official Analytical Chemists. 14^{th} Edition. 1984. Association of Official Analytical Chemists, Inc. Arlington, Va.

Tsao, G. T. & L.-C. Chiang. 1983. Cellulose and Hemicellulose Technology. Chapter 12 (Pages 296-326, In: The Filamentous Fungi. Volume 4. Fungal Technology. Edward Arnold. London.

Van Griensven, L. J. L. D., Ed. 1988. The Cultivation of Mushrooms. Darlington Mushroom Laboratories Ltd. Rustington, Sussex, England. 515 pages.

Wood, D. 1998. Substrate bioconversion by Agaricus bisporus. Pages 17-23, In: The Proceedings of the '98 Nanjing International Symposium on the Science and Cultivation of Mushrooms. Nanjing, China

It will be apparent to those skilled in the art that various modifications and variations can be made in the methods and apparatus of the present invention without departing from the spirit or scope of the invention. Thus, it is intended that the present invention covers the modifications and variations of this invention provided they come within the scope of the appended claims and their equivalents.

What is claimed is:

1. An enriched mushroom compost supplement, wherein the enrichment comprises the addition of a polysaccharide or polysaccharide composition to a mushroom compost supplement.

2. An enriched mushroom compost supplement of claim 1, wherein said enriched mushroom compost supplement provides a significantly higher mushroom yield when compared to a mushroom compost supplement lacking the enrichment.

3. An enriched mushroom compost supplement of claim 1, wherein said polysaccharide or polysaccharide composition is selected from the group consisting of cellulose, bond paper, newsprint, straw, starch, hemicellulose, cellobiose, glycogen, trehalose and BIODAC.

4. An enriched mushroom compost supplement of claim 1, wherein said polysaccharide or polysaccharide composition contains cellulose or cellulose-containing ingredients.

5. An enriched mushroom compost supplement of claim 1, wherein said enriched mushroom compost supplement dampens or suppresses temperature surges during spawn run.

6. An enriched mushroom compost supplement of claim 1, wherein said enriched mushroom compost supplement does not require additional antimicrobial or preservative treatment.

7. An enriched mushroom compost supplement of claim 1, wherein said enriched mushroom compost supplement suppresses or reduces the growth of pest and pathogen microorganisms.

8. An enriched mushroom compost supplement of claim 1, wherein said enriched mushroom compost supplement consists solely of polysaccharides.

9. An enriched mushroom compost supplement of claim 1, wherein said polysaccharide or polysaccharide composition comprises from about 10% to about 20% of the dry weight of said enriched mushroom compost supplement.

10. An enriched mushroom compost supplement of claim 1, wherein said polysaccharide or polysaccharide composition comprises from about 20% to about 30% of the dry weight of said enriched mushroom compost supplement.

11. An enriched mushroom compost supplement of claim 1, wherein said polysaccharide or polysaccharide composition comprises from about 30% to about 40% of the dry weight of said enriched mushroom compost supplement.

12. An enriched mushroom compost supplement of claim 1, wherein said polysaccharide or polysaccharide composition comprises from about 40% to about 50% of the dry weight of said enriched mushroom compost supplement.

13. An enriched mushroom compost supplement of claim 1, wherein said polysaccharide or polysaccharide composition comprises from about 50% to about 60% of the dry weight of said enriched mushroom compost supplement.

14. An enriched mushroom compost supplement of claim 1, wherein said polysaccharide or polysaccharide composition comprises from about 60% to about 70% of the dry weight of said enriched mushroom compost supplement.

15. An enriched mushroom compost supplement of claim 1, wherein said polysaccharide or polysaccharide composition comprises from about 70% to about 80% of the dry weight of said enriched mushroom compost supplement.

16. An enriched mushroom compost supplement of claim 1, wherein said polysaccharide or polysaccharide composition comprises from about 80% to about 90% of the dry weight of said enriched mushroom compost supplement.

17. An enriched mushroom compost supplement of claim 1, wherein said polysaccharide or polysaccharide composition comprises from about 90% to about 100% of the dry weight of said enriched mushroom compost supplement.

18. An enriched mushroom compost supplement of claim 1 comprising from about 0% to about 10% (dry weight) of any one of Formula 7, Formula 8, Formula 9 or Formula 10.

19. An enriched mushroom compost supplement of claim 1 comprising from about 10% to about 20% (dry weight) of any one of Formula 7, Formula 8, Formula 9 or Formula 10.

20. An enriched mushroom compost supplement of claim 1 comprising from about 20% to about 30% (dry weight) of any one of Formula 7, Formula 8, Formula 9 or Formula 10.

21. An enriched mushroom compost supplement of claim 1 comprising from about 30% to about 40% (dry weight) of any one of Formula 7, Formula 8, Formula 9 or Formula 10.

22. An enriched mushroom compost supplement of claim 1 comprising from about 40% to about 50% (dry weight) of any one of Formula 7, Formula 8, Formula 9 or Formula 10.

23. An enriched mushroom compost supplement of claim 1 comprising from about 50% to about 60% (dry weight) of any one of Formula 7, Formula 8, Formula 9 or Formula 10.

24. An enriched mushroom compost supplement of claim 1 comprising from about 60% to about 70% (dry weight) of any one of Formula 7, Formula 8, Formula 9 or Formula 10.

25. An enriched mushroom compost supplement of claim 1 comprising from about 70% to about 80% (dry weight) of any one of Formula 7, Formula 8, Formula 9 or Formula 10.

26. An enriched mushroom compost supplement of claim 1 comprising from about 80% to about 90% (dry weight) of any one of Formula 7, Formula 8, Formula 9 or Formula 10.

27. An enriched mushroom compost supplement of claim 1 comprising from about 90% to about 95% (dry weight) of any one of Formula 7, Formula 8, Formula 9 or Formula 10.

28. A method of increasing mushroom yield of a mushroom comprising the steps of:
a) adding an enriched mushroom compost supplement of claim 1 to a mushroom compost,
b) allowing the development of mature mushrooms; and
c) harvesting said mature mushrooms.

29. A method of claim 28, wherein the yield of said mature mushrooms is significantly increased when compared to a yield of mature mushrooms grown in the absence of said enriched mushroom compost supplement.

30. A method of claim 28, wherein said mushroom is a Basidiomycete.

31. A method of claim 28, wherein said mushroom is a fleshy Basidiomycete.

32. A method of claim 28, wherein said mushroom is selected from the group consisting of Agaricus bisporus, Lentinula edodes (formerly Lentinus edodes), Pleurotus spp., Flammulina velutipes, Stropharia rugosoannulata and Volvariella spp.

33. A method of supplementing a mushroom compost comprising the step of:
a) adding an enriched mushroom compost supplement of claim 1 to said compost; wherein said enriched mushroom compost supplement constitutes from about 1% to about 20% of the dry weight of said compost.

34. A method of supplementing a mushroom compost comprising the step of:
a) adding an enriched mushroom compost supplement of claim 1 to said compost; wherein said enriched mushroom compost supplement constitutes from about 2% to about 10% of the dry weight of said compost.

35. A method of supplementing a mushroom compost comprising the step of:
a) adding an enriched mushroom compost supplement of claim 1 to said compost; wherein said enriched mushroom compost supplement constitutes from about 2% to about 5% of the dry weight of said compost.

36. The enriched mushroom compost supplement of claim 4, wherein said cellulose or cellulose-containing ingredients have been treated to increase the bioavailability of cellulose.

37. An enriched mushroom compost supplement comprising elemental sulfur.

38. An enriched mushroom compost supplement comprising elemental sulfur of claim 37, wherein said elemental sulfur comprises from about 0.05% to about 0.1% (dry weight) of the enriched mushroom compost supplement.

39. An enriched mushroom compost supplement comprising elemental sulfur of claim 37, wherein said elemental sulfur comprises from about 0.1% to about 0.15% (dry weight) of the enriched mushroom compost supplement.

40. An enriched mushroom compost supplement comprising elemental sulfur of claim 37, wherein said elemental sulfur comprises from about 0.15% to about 0.2% (dry weight) of the enriched mushroom compost supplement.

41. An enriched mushroom compost supplement comprising elemental sulfur of claim 37, wherein said elemental sulfur comprises from about 0.2% to about 0.25% (dry weight) of the enriched mushroom compost supplement.

42. A method of significantly reducing mushroom compost temperatures during a spawn run comprising the step of:
a) adding an enriched mushroom compost supplement comprising elemental sulfur to a mushroom compost;
wherein the temperature of the mushroom compost is significantly reduced during the spawn run when compared to a mushroom compost lacking the enriched mushroom compost supplement comprising elemental sulfur.

43. A method of claim 42, wherein said elemental sulfur comprises from about 0.05% to about 0.1% (dry weight) of the enriched mushroom compost supplement.

44. A method of claim 42, wherein said elemental sulfur comprises from about 0.1% to about 0.15% (dry weight) of the enriched mushroom compost supplement.

45. A method of claim 42, wherein said elemental sulfur comprises from about 0.15% to about 0.2% (dry weight) of the enriched mushroom compost supplement.

46. A method of claim 42, wherein said elemental sulfur comprises from about 0.2% to about 0.25% (dry weight) of the enriched mushroom compost supplement.
